(19) United States
(12) Patent Application Publication
(10) Pub. No.: US 2005/0114088 A1
(43) Pub. Date: May 26, 2005

(54) Methods and systems for component wear prediction

(76) Inventors: Ellis E. Gorden, Buckner, MO (US); William R. Rader, Shawnee, KS (US)

Correspondence Address: HOVEY WILLIAMS LLP, Suite 400, 2405 Grand, Kansas City, MO, 64108, US

(21) Appl. No.: 10/997,132

(22) Filed: Nov. 24, 2004

Related U.S. Application Data
(60) Provisional application No. 60/524,724, filed on Nov. 24, 2003.

(51) Int. Cl. G06F 15/00

(52) U.S. Cl. 702/185

(57) ABSTRACT

Methods and systems are disclosed for detecting imminent engine failure. The methods and systems involve receiving, in real-time, on-board machine parameters associated with a piece of heavy equipment, the on-board machine parameters comprising fuel consumption and fluid temperature; receiving time correlated external machine parameters associated with the piece of heavy equipment, the external machine parameters comprising outside ambient temperature, engine oil sample analysis, and operator observations; recording failure event information associated with actual engine failures; and calculating an estimated failure time for the engine based on the on-board machine parameters, the external machine parameters, and the failure event information.

### RELATED APPLICATIONS

This application claims priority of the provisional patent application entitled METHODS AND SYSTEMS FOR COMPONENT WEAR PREDICTION, Ser. No. 60/524,724, filed Nov. 24, 2003, which is hereby incorporated into the present application by reference in its entirety.

### FIELD

The present teaching relates to systems and methods for component wear prediction.

### BACKGROUND

Engines and transmissions are examples of components of heavy equipment machinery that comprise a significant portion of the cost of the machinery. Moreover, various machine components, for example, have a definite life span after which they need to be rebuilt. However, when a component experiences a catastrophic failure the expense of rebuilding the component is much more than when the component is rebuilt near the end of its life span. Additionally, it is inefficient to rebuild a component before the end of its expected life span. Accordingly, methods and systems are needed for predicting the time of catastrophic failure of a component so that it can be rebuilt shortly prior to that time.

### SUMMARY

Methods and systems are provided for detecting imminent engine failure. The methods and systems involve receiving, in real-time, on-board machine parameters associated with a piece of heavy equipment, the on-board machine parameters comprising fuel consumption and fluid temperature; receiving time correlated external machine parameters associated with the piece of heavy equipment, the external machine parameters comprising outside ambient temperature, engine oil sample analysis, and operator observations; recording failure event information associated with actual engine failures; and calculating an estimated failure time for the engine based on the on-board machine parameters, the external machine parameters, and the failure event information.

A detailed analysis of a sample of engine, transmission, drop box, axle or hydraulic oils is a valuable preventative maintenance tool when sampled properly, recorded, and analyzed in conjunction with previous samples. A single sample of oil though, while providing information as to the present state of a component, does not provide trend data that is sufficient to reliably determine actual wear levels of a particular component. Further, we have discovered that fuel consumption and other electronically monitored parameters, used in connection with oil sample trend analysis can provide important information about the wear of a machine component that was heretofore unavailable. Understanding trend analysis combined with the information available through electronic monitoring of components enables identification of potential problems before a catastrophic failure occurs. Methods and systems consistent with the present invention can provide machine operators the ability to reduce the frequency, for example, of oil-changes thereby reducing operating cost, and further to generally predict the optimal time to perform maintenance on or to overhaul a particular machine component such as an engine, transmission, drop-box, or axle, or hydraulic component such as a pump, valve, or cylinder.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram of a system consistent with the present invention for providing wear indications based on information obtained about components in a machine;

FIG. 2 is a flow diagram indicating an exemplary process for obtaining information regarding machine components while the machine is being operated;

FIG. 3 is a flow diagram illustrating an exemplary process of combining information regarding components of a machine to predict wear and potential imminent failure of components of the machine; and

FIG. 4 is a data diagram illustrating the types of information input into an exemplary system consistent with the present invention for providing alerts and reports regarding the predicted wear of machine components.

### DESCRIPTION OF VARIOUS EMBODIMENTS

Reference will now be made in detail to some embodiments, examples of which are illustrated in the accompanying drawings. Wherever possible, the same reference numbers are used throughout the drawings to refer to the same or like parts.

Combination of Oil Analysis, Fuel Consumption, and Electronic Monitoring

Consistent with the present invention, some equipment can safely run two or three times longer than recommended intervals. The oil analysis may show that you are changing the oil more often than necessary—or not often enough. When combined with fuel usage trends, and electronic component parameter trend analysis, oil sample trend analysis can provide an important means for measuring component wear as it is occurring or shortly after it has occurred. Because of high costs associated with repair of catastrophic failures, it would be advantageous to be able to predict high wear and component overhaul requirements in advance of the occurrence of catastrophic problems.

Oil Analysis

Oil analysis involves sampling and analyzing the composition of a lubricant such as oil, that has been running in any component for a sufficient period of time for particles associated with component wear and contamination to become suspended in the oil for example as minute particles. Generally, moving, metallic, mechanical parts produce metallic trace particles that become suspended in oil. The concentration of such particles is typically measured in parts per million (ppm) in an oil analysis sample.

Oil Sample Trend Analysis

Oil sample trend analysis is simply the repeated sampling of oil, for example, on a regularly scheduled basis. Such trend analysis can involve recording each analysis and comparing each such analysis to previous samples. In so doing, a technician can establish normal wear patterns in the component and quickly spot extreme wear conditions. Individual samples can help identify such problems as: (i) water or antifreeze suspended in the oil, indicating a cooler or gasket leak; (ii) fuel dilution, indicating fuel pump, injector, or piston ring problems; (iii) silica, carbon, ash, or lead salts and oxidations, indicating dirty oil or a component that has been exposed to extreme conditions and may need to have the oil changed on a more frequent basis. Moreover, oil sample trend analysis can indicate the viscosity change in the oil, thereby indicating a possible misapplication or incorrect selection of the lubricant being used. Trend analysis makes it possible to compare the concentrations over time of wear metals such as iron, aluminum, chrome, copper, lead, and zinc, which are indicators of wear between moving metal parts in contact with each other. Under any conditions, some amount of these metal particles will be present in oil, and a steady reading in oils operated for similar lengths of time under similar conditions will indicate normal wear while a large increase in any single sample may be an indication of extreme wear or imminent failure.

Physical Tests Measured & Reported Within a Normal Sample

Antifreeze forms a gummy substance that may reduce oil flow. It leads to high oxidation, oil thickening, high acidity, and component failure if not corrected.

Fuel dilution thins oil, lowers lubricating ability, and might drop oil pressure. This usually causes higher wear.

Oxidation measures gums, varnishes and oxidation products. High oxidation from oil used too hot or too long can leave sludge and varnish deposits and thicken the oil.

Total base number generally indicates the acid-neutralizing capacity still in the lubricant.

Total solids include ash, carbon, and lead salts from gasoline engines, and oil oxidation.

Viscosity is a measure of oil's resistance to flow. Oil may thin due to shear in multi-viscosity oils or by dilution with fuel. Oil may thicken from oxidation when run too long or too hot. Oil also may thicken from contamination by antifreeze, sugar and other materials

Metal Tests Measured & Reported Within a Normal Sample

Aluminum (Al): Thrust washers, bearings and pistons are made of this metal. High readings can be from piston skirt scuffing, excessive ring groove wear, broken thrust washers, and stator damage.

Boron, Magnesium, Calcium, Barium, Phosphorous, and Zinc: These metals are normally from the lubricating oil additive package. They involve detergents, dispersants, and extreme-pressure additives.

Chromium (CR): Normally associated with piston rings. High levels can be caused, for example, by dirt entering an engine through the air intake or broken rings.

Copper (CU), Tin: These metals are normally from bearings or bushings and valve guides. Oil coolers also can contribute to copper readings along with some oil additives. In a new component, the concentration of such particles is typically high during break-in, and declines within a few hundred hours of operation.

Iron (Fe): This can come from many places such as liners, camshafts, crankshaft, valve train, gears, shafts, and/or wear sleeves.

Lead (Pb): Use of leaded gasoline will cause very high test results. Also associated with bearing wear, but fuel source (leaded gasoline) and sampling contamination (use of galvanized containers for sampling) are critical in interpreting this metal.

Silicon (Si): High readings generally indicate dirt or fine sand contamination from a leaking air intake system, or dirty or ineffective air cleaner or breathers. Such particles would act as an abrasive, causing excessive wear.

Sodium (Na): High readings of this metal normally are associated with a coolant leak, but can be from an oil additive.

Oil Sampling

Proper Sampling techniques are important for obtaining good information from your oil analysis program.

Samples should be taken in a clean container, (plastic container bottles are commonly available from oil analysis laboratories for a nominal fee and are preferred). It is imperative that external contaminants are prevented from entering the sample, (such as dust, rain, grease, or solvents).

Samples should be taken after the component has been running long enough for the oil to be at the normal operating temperature.

If a sample is taken from the drain plug of any component, some oil flow should be allowed to prevent getting any settlings that might have built up in the drain sump.

If possible a suction device should be used to obtain a sample from the middle of any oil sump or in an area that will provide a sample of the typical oil in the sump.

Viscosity Lack of lubrication Fuel dilution, blow-by gases, oil oxidation,

Change carburetor choke, ignition timing, injectors, injector pump, oil pressure

Water/Anti-Coolant leak or Coolant supply, gasket sealed, hose freeze condensation connection, oil filler cap and breather

Optimum Maintenance Interval

In the past, oil change intervals, maintenance schedules, and major overhaul intervals for all power train components were decided by the “average need.” However, no two pieces of equipment have the same preventive maintenance needs. Each machine has different imperfections and is used under different conditions. Operators doing smaller or lighter jobs can cause different conditions on power-train wear than those that occur during more extended use. Consistent with the present invention, oil analysis is one component that can be used to determine maintenance intervals.

Fuel Consumption Based Maintenance

Oil sampling, although quick and inexpensive, is a diagnostic tool more than a scheduling tool.

To obtain further information regarding the wear occurring in a machine, fuel consumption rate is a standard by which service intervals and component rebuilds can be scheduled. Consistent with the present invention, in connection with other measurable parameters the amount of fuel a machine burns provides information regarding the amount of wear the machine is experiencing.

Heavy Loads Accelerate Wear

The severity of the load or duty on any component is related to the fuel burned. Engines, transmissions, drop-boxes, and axle components experiencing more wear when placed under heaver loading conditions. For example, certain engines burn approximately 70 gallons of fuel for every quart of oil sump capacity between service intervals. Other power-train components should have their service intervals set at about every four engine oil changes. An example metric for scheduled engine rebuilds is 100 gallons of fuel burned for every cubic inch of engine size and when this parameter is combined with other parameters measured over time a precise estimate can be made regarding when an engine should be overhauled.

Electronic Monitoring Systems

Many modern vehicles and machines on-highway and/or off-highway come equipped with an electronic monitoring system. Engines in particular, and in general, many of the power-train components are electronically monitored and recorded to give the maintenance crew and operations another tool to determine maintenance intervals and schedules. Used in conjunction with Oil analysis and Fuel Consumption based maintenance procedures the present invention makes it now possible to practically eliminate catastrophic maintenance or repairs. The following are examples of electronically monitored items that can be employed, consistently with the present invention to enable prediction of component wear.

Engines
Crank case blow by; higher than normal blow by indicates ring wear, or improperly seated valves
Oil Pressure: low oil pressure indicates worn oil pump or leakage somewhere in the system High oil pressure indicates plugged system
Exhaust Temperature: High exhaust temperature indicates worn or improperly seated valves Air cleaner restriction: Plugged or dirty air cleaners allowing abrasive material in the engine which causes internal wear
Tachometers or engine RPM; Used to determine over-speeds and to monitor Engine Rpm and to determine transmission shifts
Water Temperature: High water temperature may indicate a crack in a cylinder head or excessively work cylinder.
Oil Temperature: High oil temperature can indicate oil level problems or contaminated oil. Consistent with the present invention if an oil temperature out of range condition occurs a recommendation of reports consistent with the present invention can be to stop operation of the machine and change the oil immediately.
Transmissions;
Oil pressure monitoring:
Low pressure; Worn Pump causing poor lubrication and additional wear
Leakage at some internal point, lines or passages,
Piston seals, Causing poor clutch application and wear
High pressure; Plugged system, lines or internal passages causing hard shifts resulting in gear tooth, shaft and spline shock loading throughout the power-train system
Clutch Activation Time; Extended or slow activation time indicates piston leakage, valve-body problems, and clutch slippage and excessive wear.
Transmission fluid Temperature: High fluid temperature can indicate extreme usage, poor transmission performance, or engine failure. Thus consistent with the present invention combining parameters that predicted other transmission failures under similar conditions can result in accurate predictions regarding a potential imminent catastrophic failure.
Time in Converter: Extended time in converter (out of lock-up) can indicate a transmission computer lock-up problem, improper transmission operation by a machine operator, or engine problems.

Indicators of Imminent Failure

Engine

While each application of a particular engine will potentially result in a different set of parameters for predicting imminent failure, the following are examples that can be correlated with known failures in that application to make customized predictions regarding the wear in a particular application.

High water temperature trends over an extended period of time can signal imminent failure.

Excessively high exhaust temperatures over time can also signal failure as well as extreme oil sample conditions, excessive blow-by, and/or trending upwards fuel usage.

Moreover, the oil pressure at idle or high idle can provide an indication of imminent failure if the pressure, for example, is observed to trend downward over a period of time such as, for example two or three days.

The above exemplary parameters can be modeled and used in combination to predict engine failure based on past failures in the same or similar application. In one embodiment, as more information becomes available in a particular application regarding failures, the predictors can be refined to make more precise predictions regarding imminent failure of components.

Transmission

Excessive amounts of metallic and clutch friction material contaminants in oil sump can indicate imminent failure, as well as higher than normal RPM at shift or during operation, hard or erratic shifting, the amount of time to complete a shift, and chatter, vibration, or shudder either measured electronically by vibration sensors or as commented upon by an operator during or after operation.

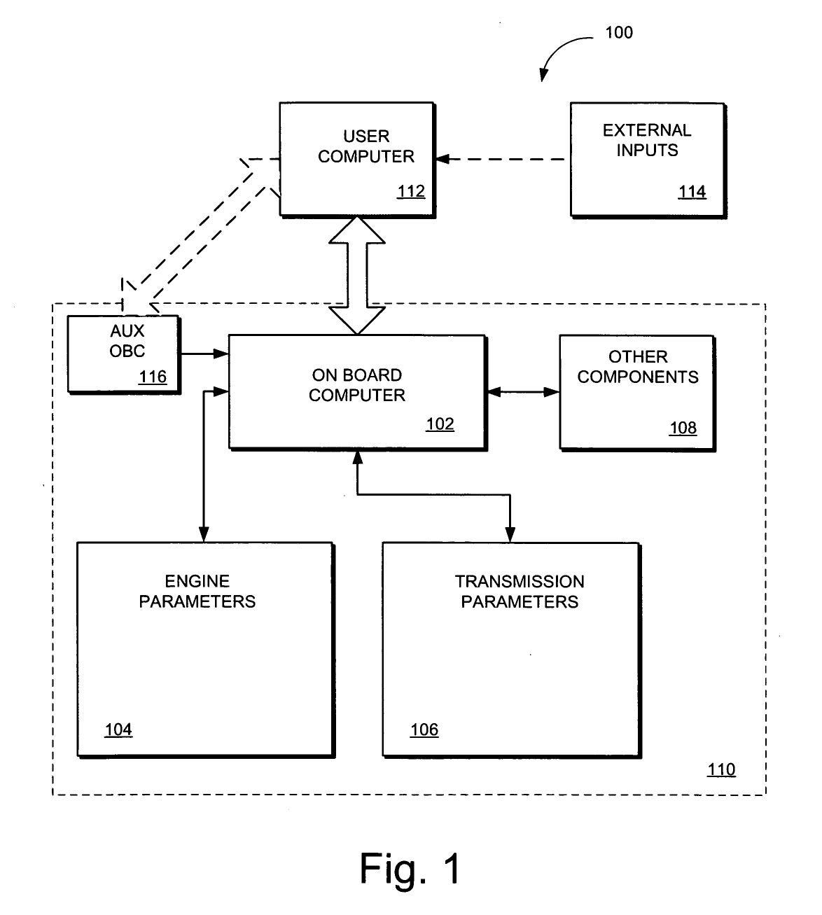

FIG. 1 is a block diagram of a system consistent with the present invention for providing wear indications based on information obtained about components in a machine. Reference numeral 100 refers to the overall system for predicting machine component wear and imminent failure. The system 100 includes a component 110, which can be any kind of machine such as on-highway or off highway trucks, construction equipment like dozers or excavators or other types of equipment. It is apparent that the system can be applied in other machine component situations such as marine or aircraft applications as well. In the machine 110 exemplary components with associated parameters are illustrated, including engine parameters 104 and transmission parameters 106. It is understood that these parameters can be obtained from analog sensors on or associated with the components, such as engine oil temperature or fuel flow, which may be measured, for example, using a flow meter that is distally located from the engine, for example nearer a fuel tank or fuel pump. Examples of components and measurable component parameters are set forth above. Additionally, oil sample trend analysis can be performed externally via removal of a sample and sending the sample to a lab or on board oil contamination sampling can be performed.

In addition, an on board computer 102 is represented in the machine 110. Typical on board computers are installed on machines at the time of manufacture by original equipment manufacturers. Typically the on board computer 102 will collect information regarding the real-time operation of the machine and many of the machine component's parameters. For example, the on board computer of a dump truck can accumulate a number of loads that were dumped from the truck during a particular period.

In one embodiment, the on board computer 102 has adequate data collection capabilities to gather sufficient information to perform wear and failure analysis computations. In this embodiment, user computer 112 communicates with the on board computer 102 via conventional communications means, including direct cable, e.g. RS232 or RS485 etc. The communications link between the on board computer 102 and the user computer 112 can also be implemented in any number of wireless and/or radio frequency communications links, such as for example the Bluetooth protocol. Additionally, a removable memory device may be used to transfer information from the on board computer 102 to the user computer 112.

In an alternative embodiment, an auxiliary on board computer (AUX OBC) 116 can be used to communicate with the con-board computer 102, for example, if the on board computer 102 lacks sufficient data logging capabilities, for example to maintain engine oil pressure trend information over a period of months. In various embodiments, the AUX OBC 116 can communicate by way of a wired or wireless communication link with the user computer 112 in order to transfer information to the user computer 112, which performs component wear and/or failure analysis. The AUX OBC 116 can also gather information from other component parameters or sensors that are not monitored by the on board computer 102. It is understood that these parameters can be measured in any manner, e.g. by sensing the variable resistance in a variable resistance temperature sensor or by counting pulses from a flow meter.

Additionally, external inputs 114 can be provided to the user computer 112 regarding, for example, oil sample data or observations made by the operator such as a vibration or unusual sound being made by the machine. Additional external inputs 114 include maintenance events such as oil changes.

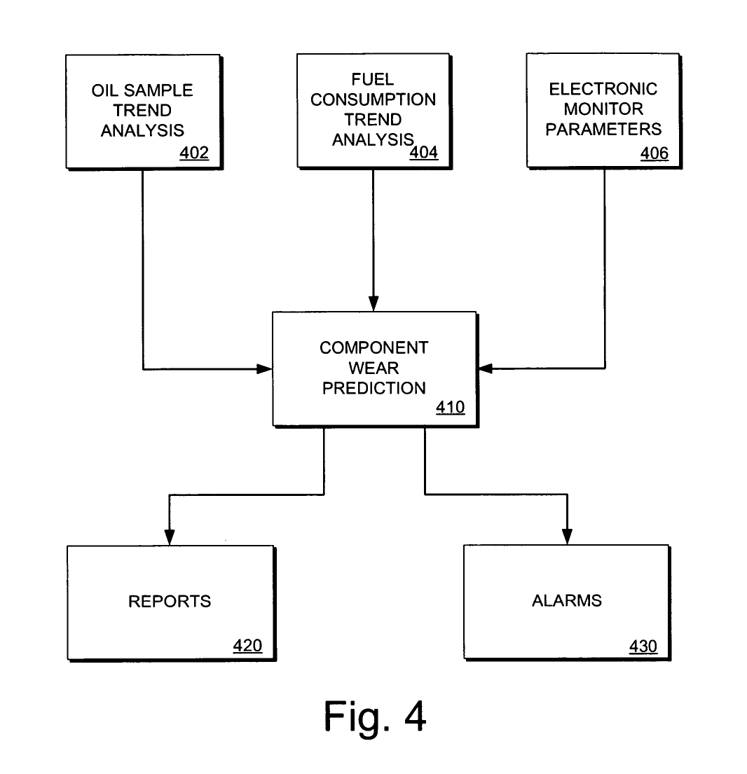

This information is collected in the user computer 112 and as also described in connection with FIG. 4, the information is applied to rules and models established by observations of other failures to predict when and if the presently observed components will require maintenance or overhaul.

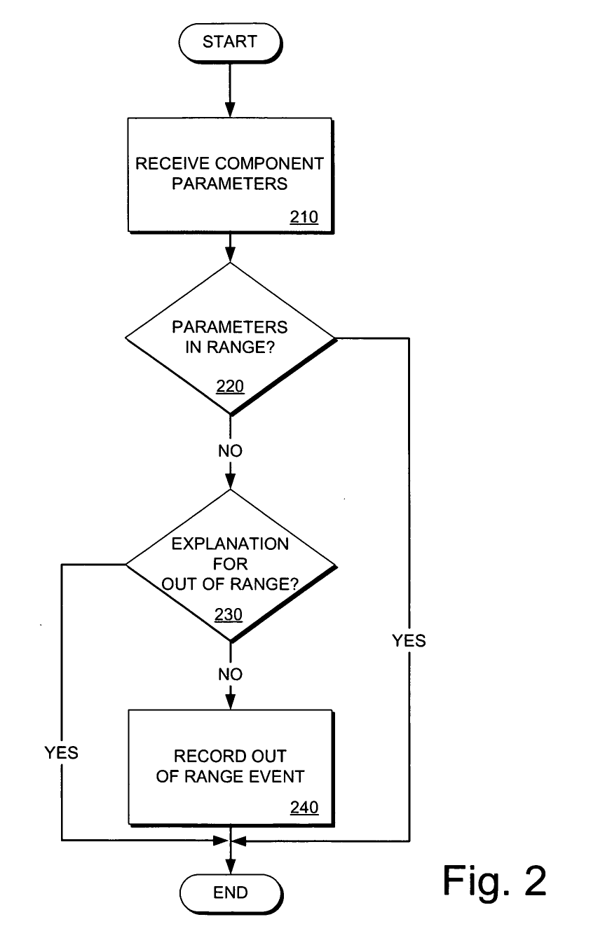

FIG. 2 is a flow diagram indicating an exemplary process for obtaining information regarding machine components while the machine is being operated. During normal operation the on board computer 102 and/or the AUX OBC 116 (both of FIG. 1) receive component parameters (stage 210). The reception of component parameters involves reading sensor values corresponding to the various pressure, temperature, flow, and vibration parameters associated with a machine component. Next it is determined whether the particular parameter is within an acceptable or desired operating range (stage 220). If the parameters are within an acceptable range the process continues to completion, optionally logging sampled information regarding the trend of values in an acceptable range. Alternatively, if the parameter is not within an acceptable range, the overall performance of the machine is optionally evaluated to determine whether there is an acceptable explanation for the out of range condition such as for example excessive outside ambient air temperature causing a slightly out of range engine coolant temperature (optional stage 230). In one embodiment stage 230 is not performed and all out of range conditions are detected. Next at stage 240 out of range conditions that are not optionally discarded as being explainable are recorded. Time and date stamps for each out of range event are optionally recorded in connection with the out of range events.

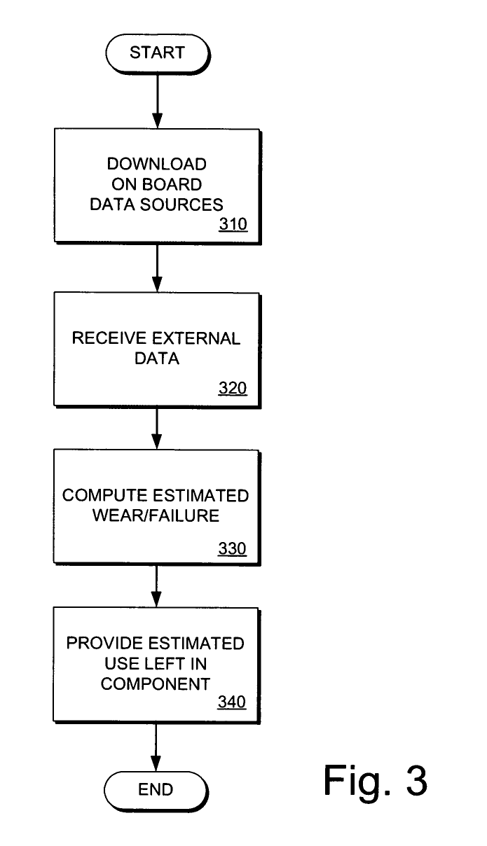

FIG. 3 is a flow diagram illustrating an exemplary process of combining information regarding components of a machine to predict wear and potential imminent failure of components of the machine. First the user computer 112 is used to download on board data sources that include or example the data stored in the on board computer 102 and the AUX OBC 116 (stage 310). In one embodiment, the AUX OBC records out of range events in oil pressure, engine water temperature, and engine exhaust temperature with corresponding time and date stamps. These counters, which may include fuel usage information, are used in connection with oil sample trend information to establish component wear and/or failure predictions. Next external information is received, for example at the user computer 112 (stage 320). This external information can involve outside ambient temperature and weather information as well as oil sample trend analysis information and operator observations regarding performance or possible problems with the machine. Next an estimated wear or failure determination is made for the machine and its associated components based on the on board and external data received (stage 330). In one embodiment, the wear determination is based on empirical data obtained in a similar application regarding component parameters prior to past failures. Next, based on the calculation and past experience an amount of estimated use in particular components is provided to users of the exemplary system of this embodiment (stage 340).

FIG. 4 is a data diagram illustrating the types of information input into an exemplary system consistent with the present invention for providing alerts and reports regarding the predicted wear of machine components. In on embodiment, oil sample trend analysis 402 is combined with fuel consumption trend analysis 404 and with data accumulated through electronic monitoring 406 of component parameters to provide a set of data parameters that can be analyzed using component wear prediction 410 rules and models, which are developed and constantly refined based on post mortem analyses of actual failures using the same monitoring system. In this way, even if the system 100 fails to predict a catastrophic failure before it occurs by refining the model used to predict failure based on the newly acquired information. Further, reports 420 are prepared that estimate a wear level on each component. Additionally, when component wear prediction 410 models are implemented in the onboard computer 102 or the AUX OBC 116 as they are in an alternative embodiment, then prediction of imminent failure based on a combination of analyzed trends can result in an alarm to the operator of the machine so that the operator can shut down the machine before the catastrophic failure occurs.

It is apparent that the invention is not limited to the specific embodiments disclosed and that persons of ordinary skill in this art could apply the principles of the present invention in different ways without departing from the scope and spirit of the present invention as disclosed and explained.

1. A method for detecting imminent engine failure comprising:
receiving, in real-time, on-board machine parameters associated with a piece of heavy equipment, the on-board machine parameters comprising fuel consumption and fluid temperature;
receiving time correlated external machine parameters associated with the piece of heavy equipment, the external machine parameters comprising outside ambient temperature, engine oil sample analysis, and operator observations;
recording failure event information associated with actual engine failures; and
calculating an estimated failure time for the engine based on the on-board machine parameters, the external machine parameters, and the failure event information.
